(19) United States
(12) Patent Application Publication
(10) Pub. No.: US 2016/0303855 A1
(43) Pub. Date: Oct. 20, 2016

(54) OPERATION SECTION AND LIQUID EJECTION DEVICE

(71) Applicant: SEIKO EPSON CORPORATION, Tokyo (JP)

(72) Inventor: Katsuya IDE, Suwa-shi (JP)

(21) Appl. No.: 15/099,511

(22) Filed: Apr. 14, 2016

(30) Foreign Application Priority Data
Apr. 15, 2015 (JP) 2015-083118

(51) Int. Cl. B41J 2/165

(52) U.S. Cl. CPC B41J 2/1652

(57) ABSTRACT

An operation section used to form a liquid ejection device that ejects liquid includes a tubular nozzle section through which the liquid is ejected, and a gripper section in which the nozzle section is so disposed as to protrude through one side of the gripper section and a tube group including a tube through which the liquid flows and a cable through which a drive signal is supplied is connected to another side of the gripper section, and the gripper section is provided with a finger position fixing section on which any of an operator's fingers rests when the operator grips the gripper section.

### BACKGROUND

1. Technical Field

The present invention relates to an operation section having a nozzle section through which liquid is ejected and a liquid ejection device including the operation section.

2. Related Art

In recent years, in a medical field, such as an incision and removal of living tissue, a liquid ejection device is used because many advantages, such as an ability to maintain the surface of living tissue at a surgical operation site at a low temperature and no injury of blood vessels and bodily parts, attract attention. A liquid ejection device ejects liquid, such as physiological saline, in the form of pulsed flow toward a living body to excise or fragmentate living tissue. A practitioner grips a handpiece (hereinafter referred to as an operation section) including a nozzle through which the liquid is ejected for medical practice (see JP-A-9-224951, for example).

As medical treatment advances, a variety of kinds of biological sites become targets of the liquid ejection device, and more accurate medical practice is required. Some medical practices require a microscope or a magnifying glass. A plurality of tubes (hereinafter referred to as a tube group) are connected to the operation section of a liquid ejection device, including a supply tube through which liquid is supplied, a suction tube through which ejected liquid and fragmented tissue are sucked, and cables through which electric power and a control signal for generation of the pulsed flow are transmitted. Therefore, in the operation of the operation section, the tube group connected to the operation section bends and twists and therefore produces reaction force, so that the posture of the operation section tends to be unstable, resulting in a difficulty in accurate operation.

### SUMMARY

An advantage of some aspects of the invention is to solve at least a part of the problems described above, and the invention can be implemented as the following forms or application examples.

### Application Example 1

This application example is directed to an operation section used to form a liquid ejection device that ejects liquid, the operation section including a tubular nozzle section through which the liquid is ejected and a gripper section in which the nozzle section is so disposed as to protrude through one side of the gripper section and a tube group including a tube through which the liquid flows and a cable through which a drive signal is supplied is connected to another side of the gripper section, wherein the gripper section is provided with a finger position fixing section on which any of an operator's fingers rests when the operator grips the gripper section.

According to the configuration described above, even when the tube group, that is, the tube and the cable are connected to the operation section, the operator who grips the operation section for operation can grip the operation section with at least one finger resting on the finger position fixing section of the gripper section. The gripper section can therefore be firmly gripped for stabilization of the posture of the operation section. As a result, the operator can readily control the position of the front end of the nozzle section of the operation section. An operation section of a liquid ejection device that allows accurate medical practice with excellent operability can be provided.

### Application Example 2

In the operation section described above, the gripper section may have a roughly cylindrical portion, the tubular nozzle section may be so disposed as to obliquely protrude at a predetermined angle with respect to an axial line of the gripper section, and the finger position fixing section may be a protrusion so disposed as to protrude in a direction facing an obtuse angle formed by an axial line of the nozzle section and the axial line of the gripper section.

According to the configuration described above, the liquid ejected through the nozzle section is ejected in a direction slightly inclined to the axial line of the gripper section. Further, the finger position fixing section is disposed as a protrusion that protrudes outward within the range of the obtuse angle (in the direction facing the obtuse angle) formed by the axial lines of the nozzle section and the gripper section. Therefore, when the operator grips the gripper section of the operation section, many fingers can be placed in the direction facing the obtuse angle, and at least one finger can be firmly placed on the finger position fixing section to firmly grip the gripper section. The obtuse angle used herein refers to an angle formed by two half lines and satisfying 90°<θ<180°.

The operator can therefore stabilize the posture of the operation section while checking an ejection position where the liquid is ejected through the nozzle section. An operation section of a liquid ejection device that allows accurate medical practice with excellent operability can therefore be provided. The operator can instead operate the operation section with the thumb placed in the direction facing a reflex angle direction corresponding to the obtuse angle described above, with the index finger resting on the finger position fixing section, and with the other fingers placing in the direction facing the obtuse angle. The reflex angle used herein refers to an angle formed by two half lines and satisfying 180°<θ<360°.

### Application Example 3

In the operation section described above, the tube group may include a cable for transmitting a drive signal to an ejection drive section that causes the liquid to be ejected through the nozzle section, a supply tube for supplying the ejection drive section with the liquid, and a suction tube for sucking the ejected liquid.

According to the configuration described above, an operation section of a liquid ejection device that allows the ejection drive section to eject the liquid supplied through the supply tube through the nozzle section and suck the ejected liquid containing fragmentated living tissue with excellent operability can be provided.

### Application Example 4

In the operation section described above, the gripper section may be provided with a suction adjuster that adjusts suction force by which the liquid is sucked through the suction tube.

According to the configuration described above, the suction of the liquid ejected by the ejection drive section through the nozzle section and the liquid containing fragmentated tissue can be initiated and terminated and the suction force can be adjusted in accordance with situations of a patient and the patient's surroundings. An operation section with excellent operability can therefore be provided.

### Application Example 5

In the operation section described above, the suction adjuster may be a hole section that is disposed in a direction facing a reflex angle corresponding to the direction facing the obtuse angle formed by an axial line of the nozzle section of the gripper section and an axial line of the gripper section, opens through an outer circumferential surface of the gripper section, and communicates with the suction tube via an outer circumference thereof, and the operator may change an open area of the hole section with a finger to adjust suction force by which the liquid is sucked through the suction tube while gripping the gripper section.

According to the configuration described above, the operator can place, for example, the operator's thumb on the hole section of the suction adjuster disposed in the gripper section and in the direction facing the reflex angle and can further rest at least one finger, for example, the index finger on the finger position fixing section and place the other fingers in the direction facing the obtuse angle to grip the gripper section. The operator can therefore move the thumb freely to some extent while firmly gripping the gripper section to adjust the suction force by changing the open area of the hole section with the thumb. As a result, even in the structure having the suction adjuster, the posture of the operation section can be stabilized. An operation section of a liquid ejection device that allows accurate medical practice with excellent operability can therefore be provided.

### Application Example 6

In the operation section described above, the finger position fixing section may be movable along an axial line of the gripper section.

According to the configuration described above, the finger position fixing section can be moved to an optimum position in accordance with the size of a practitioner's hands, how the practitioner grips the operation section, and other factors. As a result, an operation section of a liquid ejection device that is highly versatile and readily operated can therefore be provided.

### Application Example 7

In the operation section described above, the finger position fixing section may be attachable and detachable to and from the gripper section.

According to the configuration described above, special usage that allows special control of the nozzle section can be achieved. Further, the operation section can be stored in a space-saving manner.

### Application Example 8

This application example is directed to a liquid ejection device including the operation section described in any of the application examples having an ejection drive section that causes liquid to be ejected through a nozzle section, a device main body section including a liquid supply mechanism that supplies the operation section with at least the liquid and a liquid suction mechanism that sucks the liquid through the nozzle section, and a tube group connected between the operation section and the device main body section and including a tube through which the liquid flows and a cable through which a drive signal is supplied.

According to the configuration described above, a liquid ejection device including the operation section that has excellent operability and allows the ejection drive section to cause the liquid supplied from the liquid supply mechanism to be ejected through the nozzle section for medical practice and liquid containing fragmentated tissue to be sucked at desired suction force in accordance with situations of a patient and the patient's surroundings can be provided.

### BRIEF DESCRIPTION OF THE DRAWINGS

The invention will be described with reference to the accompanying drawings, wherein like numbers reference like elements.

FIG. 1 is a schematic view showing an overall configuration of a liquid ejection device.

FIGS. 2A to 2C are schematic configuration diagrams showing an operation section.

FIG. 3 is a diagrammatic cross-sectional view showing the internal configuration of a pulsed flow applying part.

FIGS. 4A and 4B describe a finger position fixing section according to a first embodiment.

FIGS. 5A to 5C show variations of the first embodiment.

FIGS. 6A and 6B describe a finger position fixing section according to a second embodiment.

### DESCRIPTION OF EXEMPLARY EMBODIMENTS

Embodiments of the invention will be described below with reference to the drawings. In the drawings that the following description refers to, a member or a portion is drawn at an aspect ratio different from an actual aspect ratio in some cases for ease of description and illustration.

Overall Configuration of Liquid Ejection Device

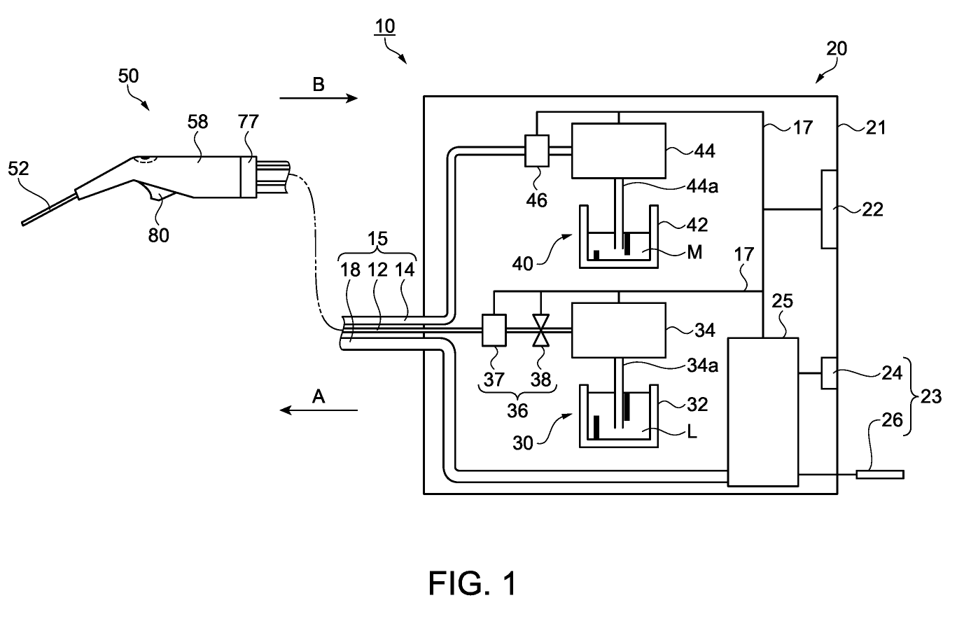

An overall configuration of a liquid ejection device 10 will be described with reference to FIG. 1. FIG. 1 is a schematic view showing the overall configuration of the liquid ejection device 10. The liquid ejection device 10 is primarily used for medical treatment and ejects a liquid L, for example, physiological saline and Ringer's solution, in the form of pulsed flow toward a medical practice target site to excise or fragmentate tissue. The liquid ejection device 10 includes a device main body section 20 and an operation section 50, as shown in FIG. 1. The device main body section 20 and the operation section 50 are connected to each other via a tube group 15.

### Device Main Body Section

The device main body section 20 will first be described with reference to FIG. 1. The device main body section 20 includes a roughly box-shaped enclosure 21 and accommodates a liquid supply mechanism 30, a liquid suction mechanism 40, and a controller 25, as shown in FIG. 1.

The enclosure 21 is provided with a display section 22 and a switch section 23. The display section 22 is formed, for example, of a liquid crystal display and displays the quantity, the flow speed, and the pressure of the supplied liquid L ejected by the liquid ejection device 10 and other types of necessary information on the liquid L. The switch section 23 includes at least a power switch 24 and an ejection switch 26. The power switch 24 is a switch that activates the liquid ejection device 10. When the power switch 24 is flipped on, electric power is supplied to the device main body section 20. The ejection switch 26 is a switch that switches the action of the operation section 50 between ejection and no ejection of the liquid L therefrom. The ejection switch 26 is preferably formed, for example, of a foot switch operated with a practitioner's foot.

The liquid supply mechanism 30 has a function of supplying the operation section 50 with the liquid L ejected from the liquid ejection device 10 and includes a liquid storage 32, a supply pump 34, and a supply quantity adjuster 36, which are sequentially arranged along the flow of the liquid L (arrow A). The liquid storage 32 is what is called a liquid reservoir and stores the liquid L, such as physiological saline and Ringer's solution, which is ejected from the liquid ejection device 10. Physiological saline and Ringer's solution, which hardly harm a living body, can be used in surgery.

The supply pump 34 can be, for example, a syringe-type pump or a tube pump. When a syringe-type pump is used, it is preferable to separately provide a device that supplies the liquid L into the syringe in consideration of continuous driving operation. A liquid acquisition tube 34a is attached to the supply pump 34, and an end portion of the liquid acquisition tube 34a is connected to the liquid storage 32. The supply pump 34 performs sucking action in the direction indicated by the arrow A to deliver the liquid L stored in the liquid storage 32 in the direction indicated by the arrow A.

The supply quantity adjuster 36 is provided in a halfway position along a supply tube 12, which is connected to the supply pump 34, and includes a supply flowmeter 37 and an electromagnetic valve 38. The supply flowmeter 37 measures the flow rate of the liquid L flowing through the supply tube 12. The supply flowmeter 37 can be, for example, a hot wire flowmeter or a turbine flowmeter. The electromagnetic valve 38 is a valve so controlled with an electric signal as to open and close, and opening and closing the valve controls the flow of the liquid L flowing through the valve. The supply quantity adjuster 36 operates the electromagnetic valve 38 on the basis of a result of the measurement performed by the supply flowmeter 37 to adjust the flow rate of the liquid L flowing through the supply tube 12. The supply tube 12 is held by the operation section 50, which will be described later. The supply tube 12 will be described later in detail.

The liquid suction mechanism 40 has a function of sucking a liquid M containing part of fragmentated tissue left after the liquid L is ejected from the liquid ejection device 10 for medical practice. The liquid suction mechanism 40 further has a function of sucking excess liquid L used in medical practice in order to ensure the field of vision of the practitioner during the medical practice. It is, however, assumed that the entire liquid sucked by the liquid suction mechanism 40 is referred to as the liquid M for ease of description.

The liquid suction mechanism 40 includes a suction flowmeter 46, a suction pump 44, and a drainage tank 42, which are sequentially arranged along the flow of the liquid M (arrow B). The suction flowmeter 46 has the same structure as that of the supply flowmeter 37 described above and is provided in a halfway position along a suction tube 14 held by the operation section 50, which will be described later. The suction flowmeter 46 measures the flow rate of the liquid M flowing through the suction tube 14. The suction pump 44 is not limited to a specific pump and can be, for example, a tube pump. The suction pump 44 performs sucking action in the direction indicated by the arrow B.

A drainage tube 44a is attached to the suction pump 44, and an end portion of the drainage tube 44a is connected to the drainage tank 42. The drainage tank 42 is what is called a liquid reservoir and stores the liquid M containing part of post-medical-practice fragmentated tissue sucked by the operation section 50 of the liquid ejection device 10. The liquid suction mechanism 40 can be further provided, as required, with a filter that is not shown but is provided along the flow path for removal of part of the fragmentated tissue.

The controller 25 is connected to the display section 22, the switch section 23, the liquid supply mechanism 30, and the liquid suction mechanism 40 described above via an internal cable 17 and oversees and controls the mechanisms described above. The controller 25 is connected to the operation section 50, which will be described later, via a cable 18, which forms the tube group 15.

### Operation Section

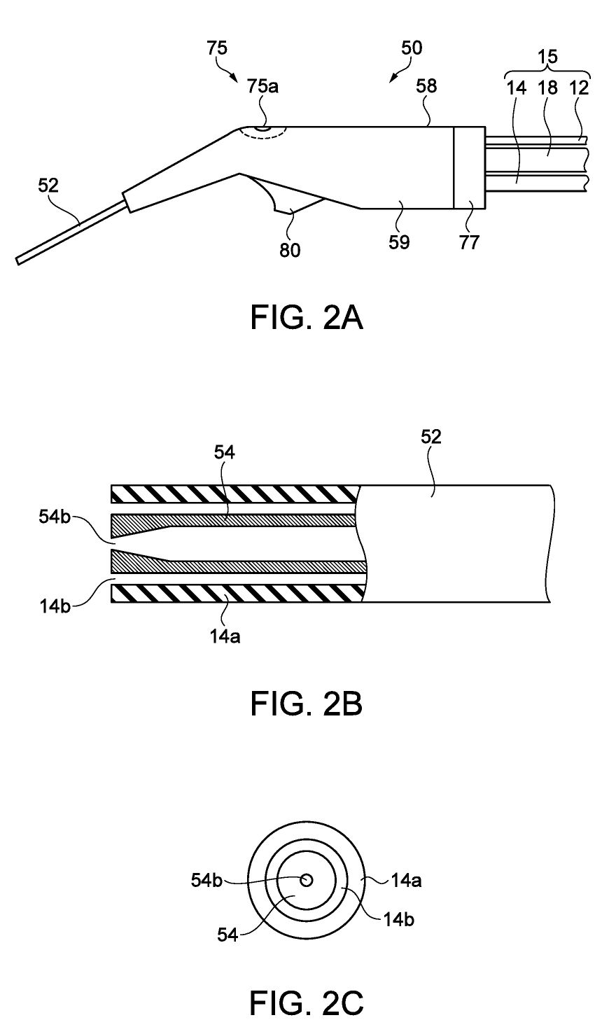

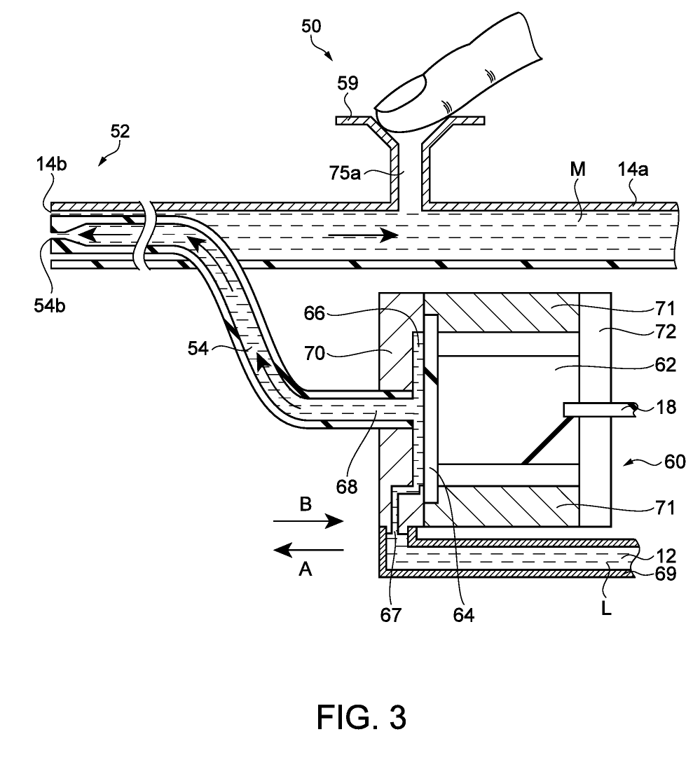

A summary of the operation section 50 will next be described with reference to FIGS. 2A to 2C and FIG. 3. FIGS. 2A to 2C are schematic configuration diagrams showing the operation section 50. FIG. 2A is an exterior appearance view. FIG. 2B is a cross-sectional view of a nozzle section. FIG. 2C shows the front end of the nozzle. FIG. 3 is a diagrammatic cross-sectional view showing the internal configuration of a pulsed flow applying part 60. The operation section 50 is a portion gripped with the practitioner's hand and operated by the practitioner for medical practice, as shown in FIG. 2A. The operation section 50 includes a nozzle section 52, a gripper section 58, and a connection section 77, which are sequentially arranged from a medical practice target site when viewed with the operation section 50 facing the medical practice target site.

The nozzle section 52 includes an ejection tube 54 and a suction tube 14a, each of which is a hollow tube, as shown in FIGS. 2B and 2C. In the present embodiment, the ejection tube 54 is, for example, a small-diameter tube through which the liquid L is ejected to a medical practice target site. The ejection tube 54 is inserted into the suction tube 14a, the inner diameter of which is greater than the outer diameter of the ejection tube 54 . That is, the ejection tube 54 is disposed at the center of the nozzle section 52, and the suction tube 14a surrounds the ejection tube 54. An ejection port 54b of the ejection tube 54 and a suction port 14b of the suction tube 14a are roughly flush with each other in a basic setting but can be positionally adjusted.

The present embodiment has been described with reference to the case where the ejection tube 54 is inserted into the suction tube 14a, but this configuration is not necessarily employed. The ejection tube 54 and the suction tube 14a may be disposed side by side, or the suction tube 14a may be disposed at the center and the ejection tube 54 may surround the suction tube 14a. Still instead, the suction tube 14a may be an extension of the suction tube 14, which forms the tube group 15, or may communicate with the suction tube 14 via a separate tube.

The gripper section 58 includes a main body case 59, the pulsed flow applying part 60 shown in FIG. 3, and a suction adjuster 75. The main body case 59 is preferably formed of a molded part made, for example, of a plastic material and has a roughly cylindrical shape so deformed that a portion close to a medical practice target site slightly narrows. The gripper section 58 is a portion gripped by the practitioner and is precisely operated for excision or fragmentation of living tissue at a medical practice target site with the ejection port 54b of the ejection tube 54 facing the medical practice target site. In this process, the practitioner passes the operation section 50 from the right hand to the left hand or vice versa and changes the way the operation section 50 is gripped in accordance with a variety of situations, such as provision of a secure field of vision with the aid of a microscope or a magnifying glass, the direction in which a target site is excised, and other medical practice tools to be used.

The pulsed flow applying part 60 as an ejection drive section is accommodated in the main body case 59. The gripper section 58 will be described later in detail.

The pulsed flow applying part 60 includes a first case 70, a second case 71, a third case 72, a piezoelectric element 62, a diaphragm 64, an inlet channel 67, an outlet channel 68, and a pump chamber 66, as shown in FIG. 3. The second case 71 is a tubular member and has one end that forms a flange, and the flange faces the first case 70 and is bonded thereto. The other end of the second case 71 is bonded to the third case 72, and a cylindrical space is formed in the second case 71. The piezoelectric element 62 is disposed in the interior space of the second case 71.

The piezoelectric element 62 is a laminated piezoelectric element and forms an actuator. One end of the piezoelectric element 62 on the side facing the first case 70 is firmly fixed to the diaphragm 64, and the other end of the piezoelectric element 62 is firmly fixed to the third case 72. The cable 18 is connected to the other end of the piezoelectric element 62, and the piezoelectric element 62 receives, through the other end thereof, a drive signal transmitted from the controller 25 in the device main body section 20. The diaphragm 64 is formed of a disk-shaped metal thin film, and the periphery of the diaphragm 64 is firmly fixed to the second case 71. The pump chamber 66, which is a space having a predetermined volume, is formed between the diaphragm 64 and the first case 70, and the volume changes in accordance with the action of the piezoelectric element 62 driven with the drive signal.

The inlet channel 67 and the outlet channel 68 are formed in the first case 70. The inlet channel 67 communicates with the side surface of the pump chamber 66. A channel 69 guided from the supply tube 12 described above is connected to the inlet channel 67. The liquid L supplied from the device main body section 20 is therefore supplied via the supply tube 12, the channel 69, and the inlet channel 67 into the pump chamber 66. The outlet channel 68 communicates with a surface of the pump chamber 66, that is, the surface thereof perpendicular to the direction in the piezoelectric element 62 is displaced. The ejection tube 54 in the nozzle section 52 is connected to the outlet channel 68. The suction tube 14a in the nozzle section 52 passes by the pulsed flow applying part 60 and extends toward the connection section 77, which will be described later.

The suction adjuster 75 is provided in the main body case 59 and in a portion where the outer diameter of the exterior of the main body case 59 slightly decreases, as shown in FIG. 2A. In the present embodiment, the suction adjuster 75 is formed as an open hole section 75a, and one end of the hole section 75a communicates with the outside air and the other end thereof connects to the inner wall of the suction tube 14a. The interior of the suction tube 14a is sucked at predetermined pressure by the liquid suction mechanism 40 in the device main body section 20. The sucking action can therefore be initiated or terminated and suction force can be adjusted by opening or closing the hole section 75a of the suction tube 14a or changing the open area of the hole section 75a. That is, the practitioner who grips the main body case 59 adjusts the suction adjuster 75 by opening or closing the hole section 75a or adjusting the open area of the hole section 75a with the thumb or the index finger.

The present embodiment has been described with reference to the case where the suction adjuster 75 is formed as the open hole section 75a and the practitioner operates the suction adjuster 75 with a finger, but the suction adjuster is not necessarily configured this way. The suction adjuster 75 may be operated, for example, with a slide switch or a foot switch.

The connection section 77 has a roughly disk-plate-shaped connection surface 78 and is disposed on the opposite side of the main body case 59 with respect to the side where the nozzle section 52 is provided. The tube group 15, which includes the supply tube 12, the suction tube 14, and the cable 18, is connected to the connection surface 78. The position on the connection surface 78 where the tube group 15 is connected thereto is not particularly specified.

The tube group 15 will now be described in detail. The connection section 77 holds the tube group 15 including the supply tube 12, the suction tube 14, and the cable 18, as shown in FIG. 2A. In the present embodiment, the supply tube is preferably formed of a tube made, for example, of high-density polyethylene. A tube made of high-density polyethylene excels in water resistance and chemical resistance and has other advantages. The suction tube 14 is preferably formed of a tube made, for example, of polyurethane. A tube made of polyurethane excels in tensile resistance and flexibility and has other advantages.

The cable 18 accommodates a power line and a signal line therein, and the exterior of the cable 18 is coated with a synthetic resin, such as silicon and polyvinyl chloride. Polyvinyl chloride excels in heat resistance, flame retardation, and environmental friendliness and has other advantages. Silicon has properties as an elastic material maintained over a wide temperature range and shows excellent resistance to ozone, humidity, electrical insulation, hot water, and chemicals.

In the present embodiment, the outer diameter of each of the tubes in the tube group 15 is so set that the supply tube 12 has the thinnest outer diameter ranging from about 2 to 3 mm and the suction tube 14 and the cable 18 have greater outer diameters or the diameters of the supply tube 12, the suction tube 14, and the cable 18 increase in this order. During medical practice, the supply tube 12 is roughly always filled with the liquid L, and the liquid M containing part of fragmentated tissue flows inside the suction tube 14 in an intermittent or continuous manner. The cable 18 accommodates a power line and a signal line therein.

The tubes in the tube group 15 therefore differ from one another in terms of rigidity. The rigidity used herein refers to the magnitude of force required to bend or twist each of the tubes or the magnitude of reaction force produced by each of the tubes when the tube attempts to restore the initial shape. Further, the degree of rigidity is determined by the outer diameter and the thickness of each of the tubes, whether or not the liquid L or M flows through the tube, the content accommodated in the tube, and other factors. The tube group 15 including the supply tube 12, the suction tube 14, and the cable 18 is connected between the device main body section 20 and the operation section 50, and each of the tubes has a length of several meters.

### Action of Liquid Ejection Device

The action of the liquid ejection device 10 will next be described with reference to FIGS. 1 to 3. In the liquid ejection device 10 having the configuration described above, when the power switch 24 on the device main body section 20 shown FIG. 1 is flipped on, electric power is supplied to the controller 25. The practitioner grips the operation section 50, orients the nozzle section 52 toward a medical practice target site, and flips on the ejection switch 26.

When the ejection switch 26 is flipped on, the supply pump 34 in the liquid supply mechanism 30 is activated, extracts the liquid L stored in the liquid storage 32 through the liquid acquisition tube 34a, and causes the liquid L to flow to the electromagnetic valve 38. When the controller 25 opens the electromagnetic valve 38, the liquid L travels as a fluid inside the supply tube 12 disposed in the device main body section 20. In this process, the supply flowmeter 37 detects the flow rate of the liquid L traveling inside the supply tube 12 and outputs the detected flow rate to the controller 25. The action of the supply flowmeter 37 allows adjustment of the quantity and pressure of the liquid L delivered from the device main body section 20. Further, the quantity and pressure of the liquid L are displayed in the display section 22 on the device main body section 20.

The liquid L delivered from the device main body section 20 travels inside the supply tube 12, which forms the tube group 15, which is connected between the device main body section 20 and the operation section 50, and reaches the operation section 50. The liquid L having reached the operation section 50 travels via the channel 69 and the inlet channel 67, which are provided in the gripper section 58, and fills the pump chamber 66 in the pulsed flow applying part 60.

The volume of the pump chamber 66 changes in accordance with the action of the piezoelectric element 62. That is, the piezoelectric element 62 expands or contracts in the direction indicated by the arrow A or B in FIG. 3 in response to the drive signal transmitted from the controller 25 in the device main body section 20 via the cable 18. When the piezoelectric element 62 expands in the direction indicated by the arrow A, the diaphragm 64 is pressed and bent by the piezoelectric element 62 in the direction indicated by the arrow A in FIG. 3, resulting in a decrease in the volume of the pump chamber 66. The liquid L in the pump chamber 66 is therefore pushed out of the pump chamber 66 and travels to the outlet channel 68. The liquid L traveling through the outlet channel 68 travels inside the ejection tube 54, which communicates with the outlet channel 68, in the nozzle section 52 and is ejected through the ejection port 54b.

When the piezoelectric element 62 contracts in the direction indicated by the arrow B, the diaphragm 64 is bent in the B direction in FIG. 3 in synchronization with the action of the piezoelectric element 62, resulting in an increase in the volume of the pump chamber 66. The liquid L is therefore supplied into the pump chamber 66 through the inlet channel 67. That is, driving the piezoelectric element 62 at a predetermined frequency allows the liquid L supplied from the liquid supply mechanism 30 in the device main body section 20 to be ejected through the ejection tube 54 in the form of pulsed jet flow. The liquid L ejected through the ejection tube 54 in the form of pulsed jet flow excises or fragmentates tissue at a medical practice target site.

At this point, the liquid M containing part of the fragmentated tissue and excess liquid L that blocks the field of vision during medical practice are also present at the medical practice target site. The following description will be made on the assumption that the liquid L once ejected through the ejection tube 54 is entirely converted into the liquid M for ease of description. The liquid M is sucked by the liquid suction mechanism 40.

When the practitioner flips the ejection switch 26 on, not only is the supply pump 34 activated, but also the suction pump 44 in the liquid suction mechanism 40 is activated roughly at the same time. The suction pump 44 performs sucking action in the direction indicated by the arrow B in FIG. 3 in the channel including the suction tubes 14 and 14a. As a result, the pressure in the suction tube 14a in the operation section 50 goes negative, and the liquid M present around the suction port 14b of the suction tube 14a is sucked.

The operation section 50 has the suction adjuster 75, as described above. The suction adjuster 75 is formed as the open hole section 75a. The practitioner opens or closes the hole section 75a or changes the open area with the thumb or the index finger while gripping the main body case 59. The practitioner can thus perform and terminate suction of the liquid M and adjust the quantity of sucked liquid M. The liquid M can be sucked in a state in which the liquid L is ejected through the ejection port 54b or in a state in which the ejection switch 26 is flipped off to stop ejecting the liquid L through the ejection port 54b. The adjustment of the quantity of sucked liquid M is preferably made in a state in which the liquid M stays at the medical practice target site or a state in which the field of vision is ensured during the medial practice.

The liquid M sucked through the suction port 14b travels through the suction tube 14a in the operation section 50 and the suction tube 14 connected to the suction tube 14a into the suction tube 14 in the device main body section 20. The liquid M having traveled into the device main body section 20 travels through the suction flowmeter 46, the suction pump 44, and the drainage tube 44a and is stored in the drainage tank 42. The suction flowmeter 46 detects the flow rate of the liquid M traveling inside the suction tube 14 and outputs the detected flow rate to the controller 25. The suction flowmeter 46 senses whether the suction is being reliably performed, how much of liquid M is stored in the drainage tank 42, and other conditions.

### Finger Position Fixing Section

### First Embodiment

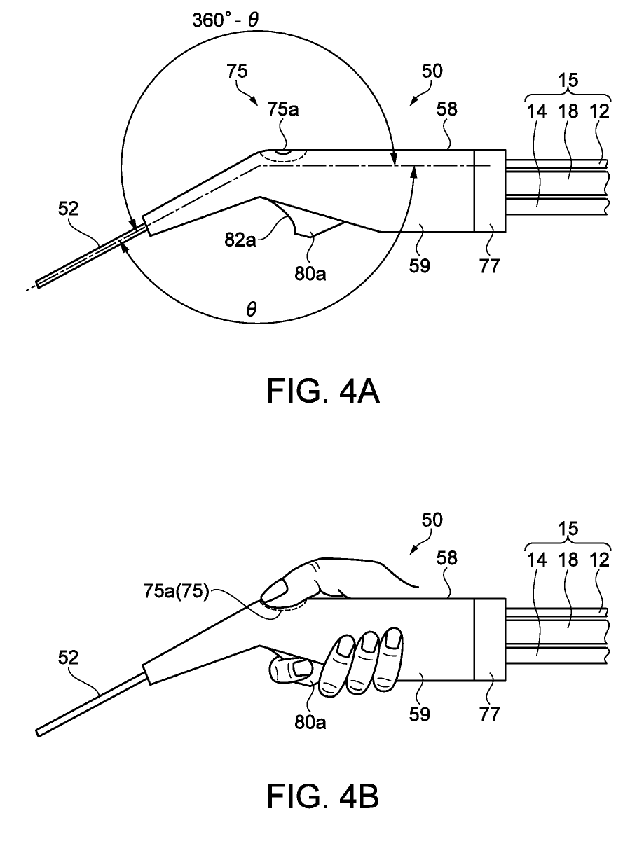

A finger position fixing section according to a first embodiment will be described with reference to FIGS. 4A and 4B. FIGS. 4A and 4B describe the finger position fixing section according to the first embodiment. FIG. 4A shows the finger position fixing section according to the first embodiment (roughly the same as FIG. 2A) , and FIG. 4B shows an example in which the practitioner grips the operation section 50. To identify the finger position fixing section in the following description, the finger position fixing section is referred to as a finger position fixing section 80, whereas to identify the finger position fixing section in each embodiment, the finger position fixing section 80 is followed by a suffix, such as finger position fixing sections 80a, 80b, . . . for distinction purposes. The same holds true for the other components.

The nozzle section 52 of the operation section 50 is inclined to the axial line of the main body case 59 of the gripper section 58 by a predetermined angle, and the axial lines of the nozzle section 52 and the main body case 59 form an obtuse angle θ, as shown in FIG. 4A. The obtuse angle used herein refers to an angle formed by two half lines and satisfying 90°<θ<180°. In other words, the direction in which the liquid is ejected through the nozzle section 52 is inclined by (180°-θ) to the direction in which the practitioner grips the operation section 50. The reason for this is that the inclined nozzle section 52 allows the practitioner to fully recognize a medical practice target site when the practitioner performs the medical practice. In particular, when medical practice is performed by using a microscope or a magnifying glass, the inclined nozzle section 52 prevents the front end of the main body case 59 or the nozzle section 52 from blocking the field of view of the microscope or the magnifying glass. When the liquid is ejected downward, the inclined nozzle section 52 is further effective.

A finger position fixing section 80a according to the first embodiment is provided in the direction facing the obtuse angle θ of the operation section 50 and in the vicinity of the position where the axial line of the nozzle section 52 intersects the axial line of the gripper section 58. The finger position fixing section 80a is formed as part of the main body case 59, is a protrusion that protrudes in the direction facing the obtuse angle, and has a finger rest section 82a on the side facing the nozzle section 52. The finger rest section 82a is formed as an arcuate recess and allows any of the fingers of the practitioner to rest on. Further, the hole section 75a of the suction adjuster 75 described above is disposed in the direction facing a reflex angle (360°-θ) corresponding to the obtuse angle θ formed by the axial lines of the nozzle section 52 and the gripper section 58 and in a position roughly facing away from the finger position fixing section 80a. The reflex angle used herein refers to an angle formed by two half lines and satisfying 180°<θ<360°.

When the practitioner grips the operation section 50 including the finger position fixing section 80a according to the first embodiment, the index finger, for example, is rested on the finger rest section 82a of the finger position fixing section 80a, and the middle finger to the little finger are used to support the main body case 59 from below, as shown in FIG. 4B. In this state, the thumb reaches the suction adjuster 75 positioned in the direction facing the reflex angle (360°-θ). That is, the practitioner can naturally place the ball of the thumb on the hole section 75a of the suction adjuster 75. The present embodiment is presented by way of example, and another finger can be placed on the hole section 75a depending on a medical practice target site and how to grip the operation section 50.

Advantageous effects provided by the first embodiment will be described below.

(1) When the practitioner grips the operation section 50 including the position fixing section 80a described above, at least one finger, for example, the index finger, is rested on the finger rest section 82a of the finger position fixing section 80a and the other fingers are placed in the direction facing the obtuse angle θ for firm grip of the gripper section 58. The gripper section 58 can thus be firmly gripped for stabilization of the posture of the operation section 50. As a result, the practitioner can readily control the position of the front end of the nozzle section 52 of the operation section 50 while checking the position where the liquid ejected through the nozzle section 52 is landed. Therefore, even when the operation section 50 is operated and the tube group 15 connected to the operation section 50 bend or twist to produce reaction force, the operation section 50 of the liquid ejection device 10 provided by the present embodiment allows accurate medical practice with excellent operability.

(2) The operation section 50 including the finger position fixing section 80a described above allows the practitioner to place a thumb on the hole section 75a of the suction adjuster 75 disposed in the gripper section 58 and in the direction facing the reflex angle. The practitioner can therefore move the thumb freely to some extent while firmly gripping the gripper section 58 to readily adjust the suction force by changing the open area of the hole section 75a with the thumb. As a result, even in the structure having the suction adjuster 75, the posture of the operation section 50 can be stabilized. The operation section 50 of the liquid ejection device 10 provided by the present embodiment therefore allows accurate medical practice with excellent operability.

### Variations of First Embodiment

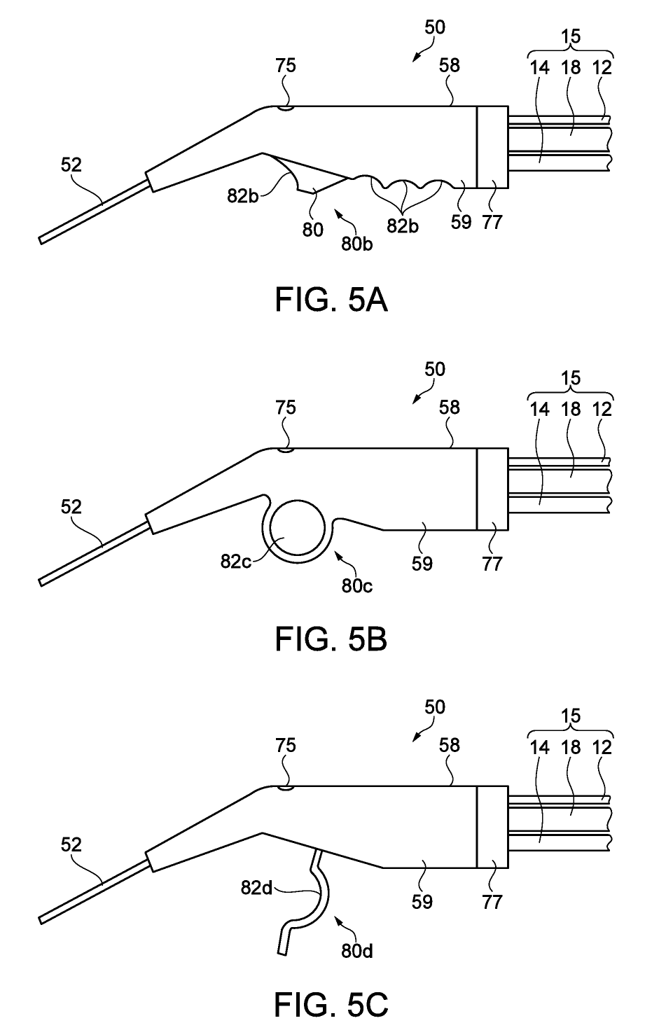

A variety of changes can be made to the first embodiment described above to the extent that the changes do not depart from the substance of the invention. For example, variations different from the embodiment described above will be described with reference to FIGS. 5A to 5C. FIGS. 5A to 5C show variations of the first embodiment.

The embodiment described above has been described with reference to the case where the finger position fixing section 80a is formed as a single arcuate recess, but the finger position fixing section is not necessarily configured this way. The finger position fixing section may be a finger position fixing section 80b shown in FIG. 5A, which has, in addition to the arcuate recess positioned in the direction toward the nozzle section 52, a finger rest section 82b, which is formed along a lower portion of the main body case 59 and formed of a plurality of arcuate recesses on which the other fingers rest. The operation section 50 including the finger position fixing section 80b allows the practitioner to firmly grip the gripper section 58 of the operation section 50 even in medical practice using liquid.

The finger position fixing section may be a finger position fixing section 80c shown in FIG. 5B, which is formed of an annular finger rest section 82c provided in the vicinity of the position where the axial line of the nozzle section 52 intersects the axial line of the gripper section 58. The operation section 50 including the finger position fixing section 80c not only allows the practitioner to firmly grip the gripper section 58 of the operation section 50 even in medical practice using liquid but also prevents the practitioner from dropping the operation section 50.

The finger position fixing section may be a finger position fixing section 80d shown in FIG. 5C, which is formed, for example, of a plate-shaped finger rest section 82d, which is narrow in the direction toward the nozzle section 52 but long in the downward direction in FIG. 5C. The thus shaped finger rest section 82d allows an increase in the flexibility in the finger rest position and further allows a space for the other fingers to be provided in the direction toward the nozzle section 52. Therefore, the practitioner can firmly grip the gripper section 58 of the operation section 50, and the flexibility in how to grip the gripper section 58 increases.

### Second Embodiment

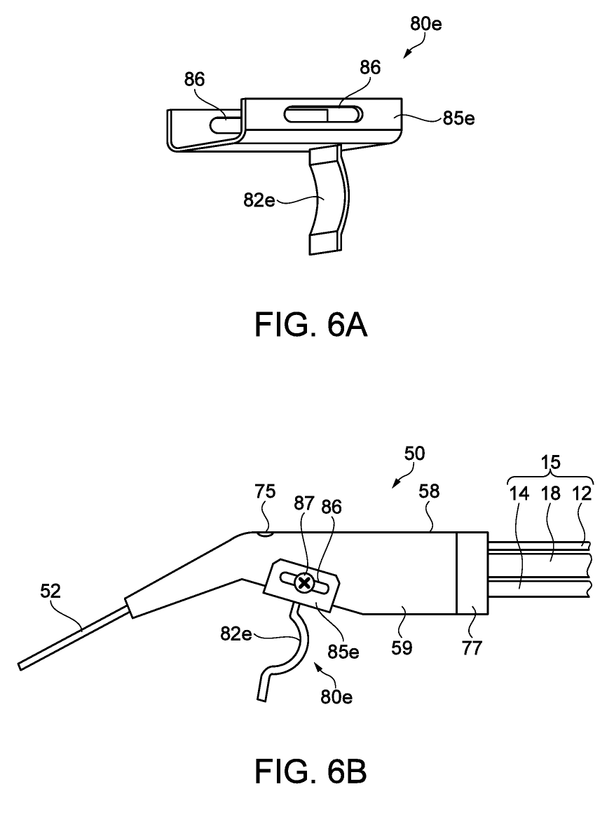

A finger position fixing section according to a second embodiment will be described with reference to FIGS. 6A and 6B. FIGS. 6A and 6B describe the finger position fixing section according to the second embodiment. FIG. 6A is an exterior perspective view of the finger position fixing section, and FIG. 6B shows an aspect in which the finger position fixing section is attached to the operation section. The same configurations and contents as those in the first embodiment have the same reference characters and will not be described.

A finger position fixing section 80e according to the second embodiment is a part independent of the main body case 59 of the operation section 50. The finger position fixing section 80e is preferably formed, for example, in metal sheet processing and has a finger rest section 82e and an attachment section 85e, as shown in FIG. 6A. The attachment section 85e is formed of a metal sheet so bent and shaped as to follow the bottom surface of the main body case 59, and raised portions formed on opposite sides of the attachment section 85e have elongated holes 86 extending in the longitudinal direction thereof. The finger rest section 82e has a roughly same shape as the shape of the finger rest section 82d, which is one of the variations of the first embodiment. That is, the finger rest section 82e is a rectangular sheet with an arcuate recess. In the present embodiment, the finger rest section 82e is formed by cutting part of the metal sheet that forms the attachment section 85e and bending the cut part.

A description will be made of a method for attaching the finger position fixing section 80e described above to the operation section 50 and the function of the finger position fixing section 80e. The attachment section 85e of the finger position fixing section 80e is disposed on the bottom surface of the main body case 59 of the operation section 50, as shown in FIG. 6B. In the present embodiment, two threaded holes that are not shown are formed through the side surface of the main body case 59 and in positions corresponding to the elongated holes 86 in the raised portions of the attachment section 85e. The finger position fixing section 80e is therefore attached to the operation section 50, for example, by fastening commercially available screws 87 through the elongated holes 86 in the attachment section 85e.

Since the elongated holes 86 are formed in the attachment section 85e of the finger position fixing section 80e, the finger position fixing section 80e, that is, the finger rest section 82e can be moved in the direction indicated by the arrow S in FIG. 6B by loosening the screws 87 and then placed in an arbitrary position by fastening the screws 87. Further, the finger position fixing section 80e can be removed from the operation section 50 by loosening and removing the screws 87.

Advantageous effects provided by the second embodiment will be described below.

The finger position fixing section 80e described above is attachable and detachable to and from the main body case 59 of the operation section 50 by attaching and detaching the screws 87. Therefore, when the operation section 50 is stored, carried, or otherwise handled, the finger position fixing section 80e can be detached for space saving. Further, the practitioner can grip the operation section 50 in a manner different from the manner described with reference to FIG. 4B by detaching the finger position fixing section 80e. For example, the practitioner can so grip the operation section 50 as to place the index finger on the hole section 75a of the suction adjuster 75 and surround the gripper section 58 with the other fingers. The operation section 50 provided by the second embodiment can therefore be a highly versatile operation section.

Since the elongated holes 86 are formed in the attachment section 85e of the finger position fixing section 80e describe above, the finger rest section 82e can be moved in the direction indicated by the arrow Sin FIG. 6B by loosening the screws 87 and placed in an arbitrary position by fastening the screws 87. The finger rest section 82e can therefore be moved and adjusted in an optimum position in accordance with the size of the practitioner's hands and how the practitioner grips the operation section 50. As a result, the operation section 50 provided by the second embodiment can be readily operated.

The second embodiment has been described with reference to the case where the finger rest section 82d, which is one of the variations of the first embodiment, is used as the finger rest section 82, and the finger rest section 82d is presented by way of example and is not necessarily used. Any of the finger rest sections 82 described in the first embodiment or any other finger rest section 82 can be used. Further, the case where the finger position fixing section 80e is attached to the operation section 50 with the screws 87 has been described, but the finger position fixing section 80e is not necessarily attached with screws. The finger rest section 82 may be fit into and attached to the main body case 59 or may be attached thereto, for example, by using a rail.

The embodiments of the invention have been described above, and a variety of changes can be made to the embodiments described above to the extent that the changes do not depart from the substance of the invention. For example, variations different from the embodiments described above are as follows.

The above embodiments have been described with reference to the case where the tube group 15 is formed of three tubes, the supply tube 12, the suction tube 14, and the cable 18, but the tube group 15 is not necessarily formed of three tubes. The liquid ejection device 10 does not necessarily have the suction function, and the tube group 15 may therefore be formed of two tubes, the supply tube 12 and the cable 18. Still instead, the liquid ejection device 10 may eject a plurality of liquids L, and two or more supply tubes 12 may therefore be provided. Further, to enhance the suction performance of the liquid ejection device 10, two or more suction tubes 14 may be provided. A liquid ejection device 10 including an operation section 50 capable of precise operation can be provided by arrangement of a plurality of tubes having different degrees of rigidity in accordance with the spirit of the invention described above.

In each of the embodiments described above, the configuration in which the piezoelectric element 62 is used as the pulsed flow applying part 60, but the piezoelectric element 62 is not necessarily used. An ejection mechanism based on a thermal jet method using a laser, a heater, and other components or a bubble jet (registered trademark) method may be used. Further, the pulsed flow applying part 60 may be disposed in a position external of the operation section 50, but the ejection tube 54 may be disposed in the operation section 50. Still further, continuous flow may be ejected as well as pulsed flow.

Since it is conceivable that the tube group 15 is exchanged in every surgery in consideration of contamination and damage in the surgery or any other situation, the tube group 15 may be attachable and detachable individually or in the form of a kit to and from the device main body section 20 and the operation section 50. Further, the material and the quality thereof described in the above embodiments are presented by way of example and are not necessarily employed.

The entire disclosure of Japanese Patent Application No. 2015-083118 filed Apr. 15, 2015 is expressly incorporated by reference herein.

What is claimed is:

1. An operation section used to form a liquid ejection device that ejects liquid, the operation section comprising:
a tubular nozzle section through which the liquid is ejected; and
a gripper section in which the nozzle section is so disposed as to protrude through one side of the gripper section and a tube group including a tube through which the liquid flows and a cable through which a drive signal is supplied is connected to another side of the gripper section,
wherein the gripper section is provided with a finger position fixing section on which any of an operator's fingers rests when the operator grips the gripper section.

2. The operation section according to claim 1,
wherein the gripper section has a roughly cylindrical portion,
the tubular nozzle section is so disposed as to obliquely protrude at a predetermined angle with respect to an axial line of the gripper section, and
the finger position fixing section is a protrusion so disposed as to protrude in a direction facing an obtuse angle formed by an axial line of the nozzle section and the axial line of the gripper section.

3. The operation section according to claim 1,
wherein the tube group includes
a cable for transmitting a drive signal to an ejection drive section that causes the liquid to be ejected through the nozzle section,
a supply tube for supplying the ejection drive section with the liquid, and
a suction tube for sucking the ejected liquid.

4. The operation section according to claim 1,
wherein the gripper section is provided with a suction adjuster that adjusts suction force by which the liquid is sucked through the suction tube.

5. The operation section according to claim 4,
wherein the suction adjuster is a hole section that is disposed in a direction facing a reflex angle corresponding to the direction facing the obtuse angle formed by an axial line of the nozzle section of the gripper section and an axial line of the gripper section, opens through an outer circumferential surface of the gripper section, and communicates with the suction tube via an outer circumference thereof, and
the operator changes an open area of the hole section with a finger to adjust suction force by which the liquid is sucked through the suction tube while gripping the gripper section.

6. The operation section according to claim 1,
wherein the finger position fixing section is movable along an axial line of the gripper section.

7. The operation section according to claim 1,
wherein the finger position fixing section is attachable and detachable to and from the gripper section.

8. A liquid ejection device comprising:
the operation section according to claim 1 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

9. A liquid ejection device comprising:
the operation section according to claim 2 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

10. A liquid ejection device comprising:
the operation section according to claim 3 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

11. A liquid ejection device comprising:
the operation section according to claim 4 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

12. A liquid ejection device comprising:
the operation section according to claim 5 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

13. A liquid ejection device comprising:
the operation section according to claim 6 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.

14. A liquid ejection device comprising:
the operation section according to claim 7 having an ejection drive section that causes liquid to be ejected through a nozzle section;
a device main body section including a liquid supply mechanism that supplies the operation section with at least the liquid and a liquid suction mechanism that sucks the liquid through the nozzle section; and
a tube group connected between the operation section and the device main body section and including a tube through which the liquid flows and a cable through which a drive signal is supplied.
